(19) United States
(12) Patent Application Publication
(10) Pub. No.: US 2021/0221011 A1
(43) Pub. Date: Jul. 22, 2021

(54) SCRAP CATCHER

(71) Applicant: Marty Mickle, Des Moines, IA (US)

(72) Inventor: Marty Mickle, Des Moines, IA (US)

(21) Appl. No.: 16/748,959

(22) Filed: Jan. 22, 2020

(51) Int. Cl. B26B 13/22; B65F 1/00

(52) U.S. Cl. CPC B26B 13/22; B65D 33/007; B65F 1/0006

(57) ABSTRACT

A device for collecting materials produced by a cutting tool includes a receptacle having a closed bottom end, an open top end, and an internal volume, and at least two connectors provided on or otherwise integrated to the receptacle proximal to the open end of the receptacle, the connectors spaced apart and occupying opposite sides of the receptacle opening, the connectors enabling connection of the receptacle to the cutting tool at least one connector per side of the receptacle, whereby the connected receptacle suspends just beneath the cutting blade footprint of the cutting tool.

### BACKGROUND OF THE INVENTION

### 1. Field of the Invention

The present invention is in the field of hand-operated cutting tools and pertains particularly to methods and apparatus for collecting scrap materials from tool cutting operations.

### 2. Discussion of the State of the Art

Hand-operated cutting tools are characterized in that opposing sharp blades of the tool are rotably hinged together, sometimes under spring tension (to stay open) and include handles or handle portions providing a grip interface for a tool operator to manually cut with the tool.

Typical cutting tools include tools commonly used by an electrician. For example, wire cutting tools and wire stripping tools are hand-operated cutting tools used by an electrician to work with electrical wires. Scrap from an electrical wire may include sharp individual wire strands (braided or bunched wires) or individual single wire ends along with wire insulation such as plastic and sometimes insulative fiber materials. Other common cutting tools that may be hand operated include sheet metal shears, scissors, PVC pipe cutting tools, garden pruning shears and tree pruning clippers. All these tools are hand-operated tools.

One drawback with utilizing these types of tools on a regular basis is the generation of scrap materials with each cutting action. Often scrap can fall to the floor or ground but must be cleaned up at some point after work is done. In some cases, scrap (typically metal) is emptied into a scrap barrel and eventually recycled. In some environments, scrap materials that get away from an operator may become contaminants in a machine assembly or may become hazards to others not aware of the presence of the materials.

Therefore, what is clearly needed are methods and apparatus for collecting scrap materials as they are produced from hand-operated cutting tools.

### BRIEF SUMMARY OF THE INVENTION

The inventor provides a device for collecting materials produced by a cutting tool including a receptacle having a closed bottom end, an open top end, an internal volume, and at least two connectors provided on or otherwise integrated to the receptacle proximal to the open end of the receptacle: the connectors spaced apart and occupying opposite sides of the receptacle opening, the connectors enabling connection of the receptacle to the cutting tool at least one connector per side of the receptacle whereby the connected receptacle suspends just beneath the cutting blade footprint of the cutting tool.

In a preferred embodiment, the receptacle is a bag formed or otherwise sewn together from fabric material. In one embodiment, the cutting tool is a hand-operated wire cutter, wire stripper, or a combination thereof. In one embodiment, the cutting tool is a plant trimmer. In the embodiment of a bag receptacle, the at least two connectors are magnets sewn into the fabric material. In a variation of this embodiment, the magnets are rare earth magnets positioned and sewn into a collar at the open end of the bag.

In one embodiment, the receptacle is a made from plastic or paper. In one embodiment wherein the receptacle is a bag, the receptacle further includes a thin wire hoop, or a thin metal spring strip sewn into or otherwise integrated into the collar to urge the open end of the bag open. In one embodiment of a bag receptacle, the receptacle further includes a zipper sewn across the bottom of the bag for opening and closing the bottom end of the bag. In one embodiment wherein the receptacle is a bag, the bag is expanded in volume beneath the collar defining the open end of the bag to hold more material.

### BRIEF DESCRIPTION OF THE SEVERAL VIEWS OF THE DRAWINGS

FIG. 1A is a front elevation view of a scrap collector device for collecting scrap materials from a hand-tool cutting operation according to an embodiment of the present invention.

FIG. 1B is a top view of scrap collector device of FIG. 1A.

FIG. 2 is an overhead view of a hand-held tool supporting the attached scrap collector device of FIG. 1A.

### DETAILED DESCRIPTION OF THE INVENTION

In various embodiments described in enabling detail herein, the inventor provides a unique scrap collector for collecting scrap materials from hand tool cutting work. The present invention is described using the following examples, which may describe more than one relevant embodiment falling within the scope of the invention.

It is a goal of the present invention to have the means to conveniently collect loose scrap materials from work activity using a pouch, bag, or other open container as a drop bucket attached to a hand-held cutting tool. The present invention is described in enabling detail using the following examples, which may describe more than one relevant embodiment falling within the scope of the present invention.

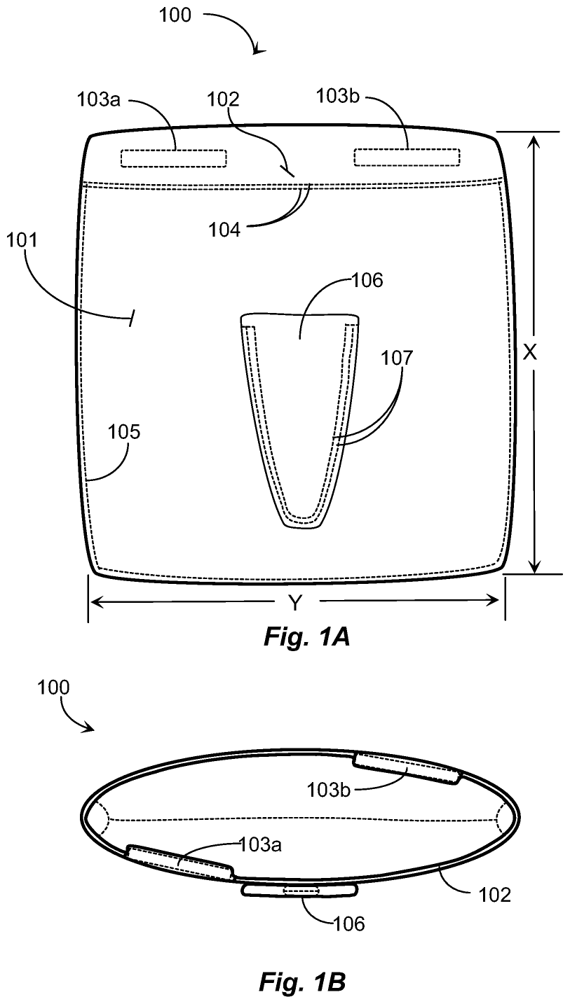

FIG. 1A is a front elevation view of a scrap collector device 100 for collecting scrap materials from a hand-tool cutting operation according to an embodiment of the present invention. FIG. 1B is a top view of scrap collector device 100. In a preferred implementation, device 100 is fabricated as a scrap collection pouch or bag and will be referred to hereinafter in this specification as scrap bag 100. Scrap bag 100 may be sewn together, via stitching 105 from a relatively thick and sturdy fabric 101. Fabric 101 may be any type of heavy material that may be folded, sewn, shaped, or otherwise manipulated to produce a bag with a closed bottom end and an open top end. For example, canvas, denim, or a woven poly bag.

Scrap bag 100 may be fabricated from a previously drawn fabric pattern sized specifically for the size of scrap bag that may be desired. Scrap bag 100 has a height dimension X and a width dimension Y, which in one embodiment, may be the same dimension. Additionally the height of the bag may be 1 to 2× the width of the scrap bag 100. Scrap bag 100 may be drawn and cut to make a rectangular form (square or rectangle) bag. Dimension X may be longer than dimension Y for a rectangular bag that may be deeper by design. Dimension Y may be larger than dimension X for a rectangular scrap bag that may be shallower by design.

Referring now to FIG. 1B, scrap bag 100 has an open top and a closed bottom (lateral stitching). Scrap bag 100 has a generally elliptical form in this embodiment; however, that should not be construed as a limitation of the present invention. Scrap bag 100 may have a rectangular form or four sides without departing from the spirit and scope of the invention.

Referring now back to FIG. 1A, scrap bag 100 is specifically designed for quick attachment to a hand-held cutting tool described as having two opposing cutting or stripping blades. Examples may include wire cutters, wire strippers, metal shears, paper scissors, garden snips and like hand-held tools adapted for removing materials and creating scrap. In this embodiment, scrap bag 100 has at least two rare earth magnets 103a, and 103b (broken boundaries) that may be positioned within and sewn into the bag material. Magnets 103a and 103b are intended to function as magnetic tool-attachment elements capable of adhering firmly to metal surfaces of a hand tool for the purpose of suspending scrap collector bag 100 directly beneath a cutting footprint of a hand tool.

Scrap collector bag 100 includes a collar 102 formed by doubling the material over and securing the material flap down with stitching 104 across the width of the bag. Bag collar 102 has an internal open space extending around the perimeter of the bag. Magnets 103a and 103b may be positioned within the collar feature 102 and may be stitched into position. In one embodiment, magnets 103a and 103b may be glued into position using a commercial grade fabric glue. Magnets 103a and 103b have a length, width, and thickness dimension suitable for the intended function of attachment of scrap collection bag 100 to a hand-tool. In one example, bag 100 may be approximately 3 inches in height X and in width Y where magnets 103a and 103b may be approximately three-quarters of an inch long and one-eighth of an inch in thickness. These figures are exemplary as scrap collector bag 100 may be fabricated for larger tools having a longer cutting plane.

Referring now to FIG. 1B, magnet 103a is sewn into the material at the collar 102 previously described above and is positioned at the front and left side of the bag 100 on the inside of the bag 100 opening. Magnet 103b is sewn into the collar material at the back and right side of the bag on the inside of the bag opening. In this embodiment, one magnet attachment element (for example 103a) is attached to one blade of a hand-held cutting tool at a point beyond the central pivot of the tool while the other magnet 103b is attached more or less at the handle/blade interface at a point on the other side of the central pivot of the hand tool.

Referring now back to FIG. 1A, scrap collector bag 100 includes an accessory pouch 106. Accessory pouch 106 may be fabricated of the same material as scrap collector bag 100. Pouch 106 may be formed by sewing or stitching a cut piece of material to the exterior of bag 100 using double stitching 107. In this embodiment, accessory pouch 106 is open at the top end to receive a tool and closed at the bottom end to protect the blade points from exposure. There may be more than one accessory pouch sewn or otherwise attached to scrap collector bag 100 without departing from the spirit and scope of the present invention.

Referring now to FIG. 1B, accessory pouch 106 is sewn on to the exterior surface of collector bag 100. Pouch 106 may be tapered down from the top to bottom generally providing a blade cover for the blade portion of a hand-held cutting tool. In this view, bottom stitching is present designating a closed bottom end of pouch 106. However, in another embodiment, the bottom portion of pouch 106 may have a small opening provided there through to allow the tool blade points to extend just through the opening of collar 102.

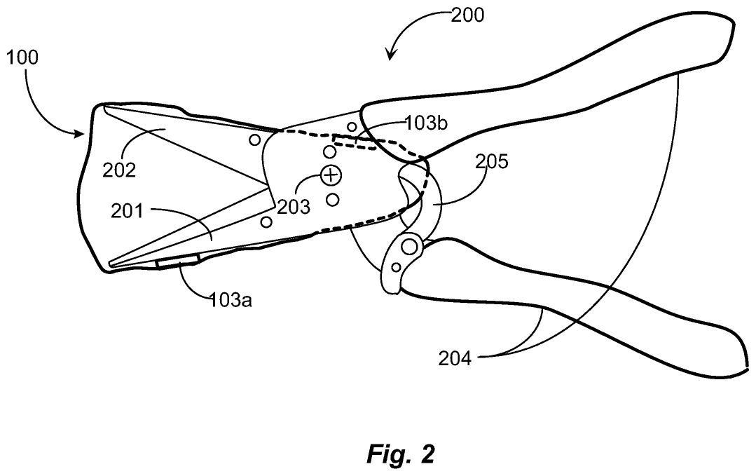

FIG. 2 is an overhead view of a hand-held tool 200 supporting an attached scrap collector device 100. Tool 200 represents any typical hand-held cutting/stripping tool. Tool 200 is an assembly that includes a first cutting blade part 201 and a second cutting blade part 202 mounted over a central blade pivot 203. Blade parts 201 and 202 include rearward extensions over which rubber grip handles 204 may be installed. Cutting tool 200 includes a spring 205 installed at one end to blade part 201 and at the other to blade part 202 at the junction of the blade parts and handles 204. This is typical for many hand-held cutting tools. However, tool 200 may not include a tension spring and does not require one to practice the invention. Additionally, the cutting tool 200 may be a hand-held electric powered cutting tool with handles or rechargeable hand tool with handles.

Hand-held tool 200 may be a snipping tool, a metal shear, a wire stripper, a wire cutter, or the like. Scrap collector bag 100 is attached in suspension below the cutting blades via attaching magnet 103a to the outer side of blade part 201 somewhat proximal to the point of the blade part, and attaching magnet 103b to the underside of or to the outside of blade part 202 somewhat proximal to the junction between the blade part and rubber handle 204. In a preferred embodiment, scrap collector bag 100 occupies a footprint directly beneath the cutting blades from beyond the blade points to just past the junction between the blade parts (201,202) and the rubber handles 204.

In general use of the present invention, Scrap collector bag 100 may be attached via magnets 103a and 103b to a hand-held cutting tool like tool 200 to be made to suspend in a quasi-open state beneath the cutting blades of the blade parts 201 and 202. In this way, the actions of cutting or stripping made by the tool produce scrap materials that fall into scrap collector bag 100 as they are removed from a work piece. A common example is wire cutting and trimming of a piece of electrical wire by an electrician where tool 200 is a wire cutter and stripping tool. In such a case the scrap wire pieces, and insulation stripped from a wire fall into scrap bag 100.

Magnets 103a and 103b may be positioned advantageously by a user having more than one hand-tool where the blades are of differing lengths or shaped differently. As the tool opens the bag expands and is still expanded during the cutting process. A user may simply remove a scrap collector bag like bag 100 from a hand-held tool like tool 200 by pulling the magnets 103a and 103b off the tool. The scrap collector device of the invention may include a semi-rigid thin wire hoop or thin metal spring strip sewn into or otherwise installed within the material collar 102 to urge the scrap collector bag to remain open at least to some extent when at rest.

In one embodiment, other attachment mechanisms might be used other than magnets without departing from the spirit and scope of the invention. The inventor prefers magnetic tool attachment elements because of convenience and superior adjust ability relative to magnet position. In a preferred embodiment, the scrap collector device 100 is a bag made from a sturdy material. In other embodiments, scrap collector device 100 may be fabricated from a thin flexible polymer or may be fabricated from a sturdy stock of paper without departing from the spirit and scope of the present invention. In one embodiment, tool 200 may be a plant trimming tool wherein the trimmings are collected to be used later, for example, trimmings in the cannabis industry. In this embodiment, or other embodiments, bag 100 may be an expandable or fold-out bag having a much greater internal volume beneath the collar defining the bag opening at the top. In one embodiment of the invention, the bottom end of scrap collector bag 100 may be opened and closed by a zipper mechanism so that it might be emptied of scrap/trimmings without breaking the magnetic attachment to the current hand-held tool.

It will be apparent to one with skill in the art that the scrap collector device of the invention may be provided using some or all the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

It will be apparent to the skilled person that the arrangement of elements and functionality for the invention is described in different embodiments in which each is exemplary of an implementation of the invention. These exemplary descriptions do not preclude other implementations and use cases not described in detail. The Uses and methods depicted within this description are purely emblematic of definitive ways in which to build and operate this invention and are not to be understood to be limiting of scope in any way. While the uses and methods have been described with a certain degree of particularity, it is to be noted that many alterations could be made in the details of the construction and the arrangement of the apparatus and its components without departing from the spirit and scope of this invention. It is implied that the uses and methods are not limited to the examples represented in this specification for the purpose of clarification and persuasion. The invention is limited only by the breadth of the claims below.

1. A device for collecting materials produced by a cutting tool comprising:
a receptacle having a closed bottom end, an open top end, and an internal volume; and
at least two connectors provided on or otherwise integrated to the receptacle proximal to the open end of the receptacle, the connectors spaced apart and occupying opposite sides of the receptacle opening, the connectors enabling connection of the receptacle to the cutting tool at least one connector per side of the receptacle, whereby the connected receptacle suspends just beneath the cutting blade footprint of the cutting tool.

2. The device of claim 1, wherein the receptacle is a bag formed or otherwise sewn together from fabric material.

3. The device of claim 1, wherein the cutting tool is a hand-operated wire cutter, wire stripper, or a combination thereof.

4. The device of claim 1, wherein the cutting tool is a plant trimmer.

5. The device of claim 2, wherein the at least two connectors are magnets sewn into the fabric material.

6. The device of claim 5, wherein the magnets are rare earth magnets positioned and sewn into a collar at the open end of the bag.

7. The device of claim 1, wherein the receptacle is a made from natural fiber, plastic or paper.

8. The device of claim 6, further including a thin wire hoop or a thin metal spring strip sewn into or otherwise integrated into the collar to urge the open end of the bag open.

9. The device of claim 2, further including a zipper sewn across the bottom of the bag for opening and closing the bottom end of the bag.

10. The device of claim 2, wherein the bag is expanded in volume beneath the collar defining the open end of the bag to hold more material.
